(19) United States
(12) Patent Application Publication
(10) Pub. No.: US 2002/0051660 A1
(43) Pub. Date: May 2, 2002

(54) Image forming apparatus

(76) Inventors: Yasunari Kobaru, Shizuoka (JP); Takashi Narahara, Shizuoka (JP)

Correspondence Address: FITZPATRICK CELLA HARPER & SCINTO, 30 ROCKEFELLER PLAZA, NEW YORK, NY, 10112, US

(21) Appl. No.: 09/925,472

(22) Filed: Aug. 10, 2001

(30) Foreign Application Priority Data
Aug. 11, 2000 (JP) 244176/2000
Aug. 3, 2001 (JP) 235721/2001

(51) Int. Cl. G03G 15/20

(52) U.S. Cl. 399/320

(57) ABSTRACT

In a conventional type of an image forming apparatus, when the top end of the paper whose charge is eliminated is brought into contact with the roller, or when the potential of the pressure roller is fluctuated by a separating discharge of the paper rear end, black spots phenomenon sometimes occurs at a portion in which the potential of the roller was lowered. It is provided, an image forming apparatus for preventing black spots of toner.

### BACKGROUND OF THE INVENTION

1. Field of the Invention

The present invention relates to an image forming apparatus such as a printer and a copier which adopts an electrophotographic system.

2. Related Background Art

Conventionally, the image forming apparatus adopting the electrophotographic system comprises: a latent image bearing body for bearing a latent image; developing means for visualizing the above described latent image as a developer image by giving a developer to the above mentioned latent image bearing body: transferring means for transferring the above mentioned developer image on a recording medium; and fixing means for fixing the above described developer image on the above described recording medium by heating and pressurizing the above described recording medium which bears the above described developer image.

Further, in such an image forming apparatus, there has been known and put into practice an image forming apparatus comprising residual charge elimination means which charge-eliminates the above described recording medium by applying a bias from a power source to the above described recording medium after the transfer of the above described developer image to the above described recording medium by the above described transferring means.

For example, in such an image forming apparatus, as shown in FIG. 7, as a method of separating a paper 114, which is the recording medium after the toner image which is the developer image was transferred, from a photosensitive drum 103 which is the latent image bearing body, a method is generally adapted wherein, by applying a bias voltage of the polarity opposite to the bias applied (hereinafter, referred to as a residual charge elimination bias) to the transferring roller 107 which is transferring means, a charge on the paper 114 is charge-eliminated and an absorption force between the photosensitive drum 103 and the paper 114 is weakened.

A residual charge elimination needle 120 has a current-limiting resistor 121 having a resistance of 5 Ω to 50 Ω connected to a power source 122 in series to prevent a current leakage due to a high voltage. In the present example, in order to prevent the bias applied to the transferring roller 107 from leaking to the residual charge elimination needle 120, a residual charge elimination needle holder 120a for shielding between the transferring roller 107 and the residual charge elimination needle 120 is installed. Note that, in general, the above described method of separating the paper 114 from the photosensitive drum 103 by the residual charge elimination needle 120 is used in combination with a method of abutting a separative claw (not shown) against the photosensitive drum 3 and forcing the paper to be stripped off after the transfer in order to enhance separability of a thin paper for the photosensitive drum 103.

In a fixing apparatus 117 provided for such an image forming apparatus, as shown in FIG. 7, the paper 114 which bears unfixed toner image T is passed through a nip formed by a roller heated from the inside by a heater 133 which is heating means, thermally fixing means 131 which is a film-shaped fixing member and a pressure roller 132 which is a pressing body and pressure-welded to the thermal fixing means 131, and heated and pressurized so that the unfixed toner image T is fixed on the paper 114.

In the recent years, in order to solve an off-set problem in such a fixing apparatus 117, there have been on the increase apparatuses having such a constitution that, on the surfaces of the thermal fixing means 131 and the pressure roller 132, a potential difference is induced in such a direction as to press an unfixed toner image on the paper 114 against the paper 114, thereby preventing the off-set toward the thermal fixing means 131.

For example, as for the fixing apparatus of the above described constitution, there are such apparatuses available wherein, by applying a bias (if a negative toner, −100 V to −2000 V) of the same polarity as the toner (unfixed toner) to the metal core of the fixing roller, a potential which repels the toner is induced on the surface, while, on the other hand, the pressure roller disperses an electrically conductive agent on an surface layer fluororesin layer and an elastic layer to make it as a medium resistive roller (having a surface resistance of 10⁷ Ω to 10¹² Ω and, by connecting a diode to the metal core, the potential difference with the fixing roller is maintained.

Or there are such apparatuses available, wherein, as shown in FIG. 7, the thermal fixing means 131 (for example, the fixing roller metal core) is grounded (of course, it may be applied with a bias of the same polarity of the toner), and the surface resistance of the pressure roller 132 is made low resistive not more than 10⁶ Ω, and the electrode of the electrically conductive brush 134 and the like applied with the bias (hereinafter, referred to as a pressure bias) of the polarity reverse to the toner by the power source 136 is brought into contact with the surface of the pressure roller 132, so that the potential difference with the thermal fixing means 131 is maintained.

This apparatus comprises a current-limiting resistor 135 of 100 MΩ to 1000 MΩ which controls a large electric current so as not to flow even if the pressure bias of high voltage continue to be applied and, comparing to the current-limiting resistor 121 of the residual charge elimination bias, high value resistor is used for the current-limiting resistor 135.

In this way, by generating a potential difference in such a direction as to press the toner on the paper, there is no more need to coat a surface lubricant such as a silicon oil and the like on the surface of the thermal fixing means as in the past or to make a cleaning member abut against the thermal fixing means or the pressure roller.

As a result, there is no more accident such as an oil leakage and the like and user's labor to periodically replace the cleaning member has been eliminated.

FIG. 8 is a chart showing a timing of the residual charge elimination bias at the time when the paper 114 passes through on the residual charge elimination needle 120 with the position of the residual charge elimination needle 120 as a reference. Note that, in FIG. 8, an arrow mark is a top end of the paper 114.

The residual charge elimination bias adequately eliminates the charge on the paper and applies a bias of −0.5 kV to −1.5 kV (hereinafter, referred to as a low level) from the top end of the paper to the halfway of the image so that the paper does not stick and pile by a guide member installed between the transferring portion and the fixing portion. While, at the paper rear end, it is preferable to strongly charge-eliminate the paper by a bias of −2 kV to −3 kV (hereinafter, referred to as high level) so that the paper does not jump up to allow the image to rub against the base of a cartridge.

By the way, usually, in the miniaturized apparatus, the paper is arranged so as to stretch across the transferring portion and the fixing portion and, when such an image forming apparatus as described above is used under high humidity, because the paper is humidified under high humidifying circumstance, the potential of the pressure roller is lowered by a strong bias applied to the residual charge elimination needle so that the paper rear end does not jump up after the toner image is transferred on the paper. For this reason, there were some cases where a force to retain the unfixed toner image on the paper runs out and black spots phenomenon on a paper (hereinafter merely referred to as black spots) occurs at the fixing portion.

That is, in the case where the fixing apparatus is an apparatus wherein the surface resistance of the pressure roller is set not more than 10⁶ Ω and the bias of the polarity reverse to the toner is applied to the pressure roller, when a strong bias of the residual charge elimination needle is applied to the paper rear end as shown in FIG. 9, the potential of the humidified paper is lowered (B of FIG. 9). Incidentally, if the paper rear end passes through the residual charge elimination needle, a charge is newly supplied from the pressure roller and the potential of the paper becomes the same as the potential applied to the pressure roller.

Further, A, C of FIG. 9 show the fluctuations of the pressure roller potential at the moment when the paper reaches the fixing nip and at the moment when the paper leaves from the fixing nip, respectively.

In this way, when the top end of the paper whose charge is eliminated is brought into contact with the roller, or when the potential of the pressure roller is fluctuated by a separating discharge of the paper rear end, the black spots sometimes occurs at a portion in which the potential of the roller was lowered.

### SUMMARY OF THE INVENTION

It is an object of the present invention to control the potential fluctuation of the fixing member and provide an image forming apparatus for preventing black spots of the toner.

It is an another object of the present invention to provide the image forming apparatus, comprising an image bearing body; transferring means for transferring a toner image on said image bearing body to a recording medium; fixing means for fixing an unfixed toner image transferred on a recording medium by said transferring means on the recording medium; voltage applying means for applying a voltage to a second fixing member which is not brought into contact with an unfixed toner image of said fixing means; and residual charge elimination means for charge-eliminating a recording medium before being fixed by said fixing means, in which said fixing means comprises a first and a second fixing members for holding and conveying the recording medium, at least a recording medium of the maximum size exists by extending from said residual charge elimination means to said fixing means, said voltage applying means comprises a first power source and a first resistor connected to said first power source in series, a voltage is applied to said second fixing member by said first power source through said first resistor, said residual charge elimination means comprises a second power source and a second resistor connected to said second power source in series, a voltage is applied to the recording medium by said second power source through said second resistor, and when the voltage value of said first power source is taken as V₀, the resistance value of said first resistor as R₀, the voltage value of said second power source as V₁, and the resistance value of said second resistor as R₁, there is a relation represented by V₀·R₁>V₁·R₀.

It is an another object of the present invention to provide the image forming apparatus, comprising an image bearing body; transferring means for transferring a toner image on said image bearing body onto a recording medium; fixing means for fixing an unfixed toner image transferred on a recording medium by said transferring means on the recording medium; voltage applying means for applying a voltage to a second fixing member which is not brought into contact with an unfixed toner image of said fixing means; and residual charge elimination means for charge-eliminating a recording medium before being fixed by said fixing means, in which said fixing means comprises a first and a second fixing members for holding and conveying the recording medium, at least the recording medium of the maximum size exists by extending from said residual charge elimination means to said fixing means, said voltage applying means comprises a power source, and a resistor and capacitor which are connected to said power source in series, and a voltage between said resistor and said capacitor is applied to said second fixing member.

It is an another object of the present invention to provide the image forming apparatus, comprising an image bearing body; transferring means for transferring a toner image on said image bearing body onto a recording medium; fixing means for fixing an unfixed toner image transferred on a recording medium by said transferring means on the recording medium; voltage applying means for applying a voltage to a second fixing member which is not brought into contact with an unfixed toner image of said fixing means; residual charge elimination means for charge-eliminating a recording medium before being fixed by said fixing means; and an electrically conductive member brought into contact with the recording medium between said residual charge elimination means and said fixing means, in which said fixing means comprises a first and a second fixing members for holding and conveying the recording medium by pressure-contacting portions mutually pressure-contacted, at least the recording medium of the maximum size exists by extending from said residual charge elimination means to said fixing means, said voltage applying means stops applying the voltage to said second fixing member when the rear end of the recording medium reaches the pressure welding portion of said fixing means, and said electrically conductive member is grounded through the capacitor.

Still another object of the present invention will be evident from the following description.

### BRIEF DESCRIPTION OF THE DRAWINGS

FIG. 1 is a view showing an image forming apparatus of an embodiment of the present invention;

FIG. 2 is a view for explaining a transferring step to a fixing step;

FIG. 3 is a circuit diagram showing a schematic configuration of residual charge elimination means and voltage applying means;

FIG. 4 is the circuit diagram when the circuit shown in FIG. 3 is divided in two parts;

FIG. 5 shows a circuit diagram showing a schematic configuration of the residual charge elimination means and the voltage applying means in another embodiment of the present invention;

FIG. 6 is a view for explaining the transferring step to the fixing step in another embodiment of the present invention;

FIG. 7 is a view for explaining the transferring step to the fixing step in the conventional image forming apparatus;

FIG. 8 is a timing chart for showing the applying timing of a bias from a power source to a recording medium by the residual charge elimination means in FIG. 7; and

FIG. 9 is a view showing the potential fluctuation of the surface of the pressing body shown in FIG. 7.

### DETAILED DESCRIPTION OF THE PREFERRED EMBODIMENTS

Embodiments of the present invention will be described with reference to the accompanying drawings.

(First embodiment)

First, the first embodiment of the present invention will be described.

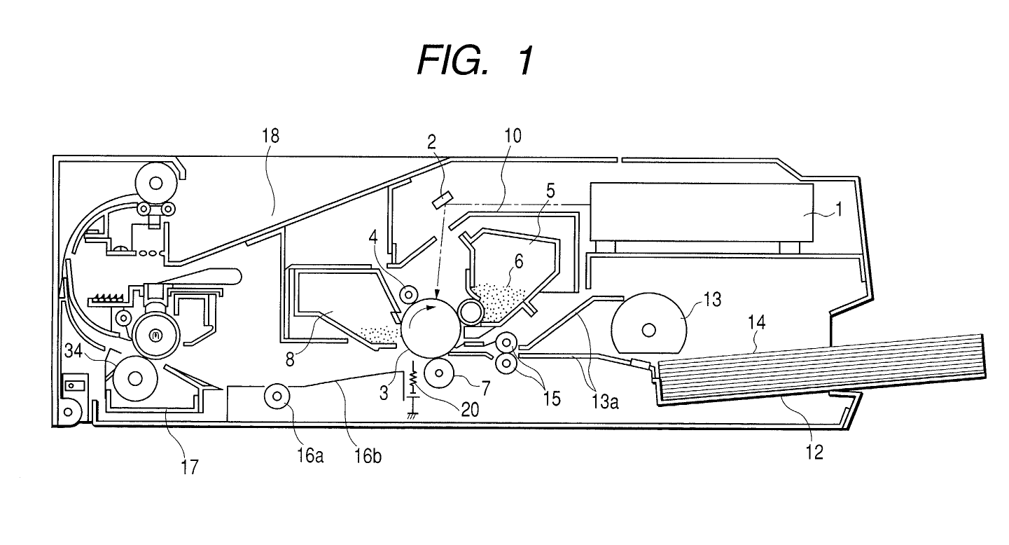

FIG. 1 is a cross sectional view showing a schematic block diagram of a laser beam printer (hereinafter, a printer) which is one example of the image forming apparatus according to the present embodiment. Such a printer is of an image forming apparatus of a type using a negative toner and executing a reverse developing.

Such a printer comprises, as shown in FIG. 1, a scanner unit 1 comprising optical means and scanning means for irradiating and scanning a laser light transmitted according to image information and a process cartridge built-in with main image forming means.

The process cartridge 10 comprises a photosensitive drum 3 which is an image bearing body for bearing a latent image and a toner image as image forming means, a roller charging device 4 composed of a semiconductor rubber, developing means 5 for developing the above described latent image by giving a toner 6 on the photosensitive drum 3 and a cleaner 8 for eliminating a waste toner from the photosensitive drum 3.

The photosensitive drum 3 inside this process cartridge 10 is rotating in an arrow mark direction and, after being uniformly charged on its surface by the roller charging device 4, an electrostatic latent image is allowed to be formed on its surface by being irradiated with the laser light transmitted from the scanner unit 1 through a mirror 2.

This electrostatic latent image is provided with a toner by the developing apparatus 5 and visualized as a toner image.

On the other hand, the paper 14 which is a recording medium inside the paper feed cassette 12 is separated and fed by one sheet each by a paper feed roller 13 and a separating pad (not shown)in opposition to the paper feed roller 13, and the fed paper 14 is conveyed to one pair of resist rollers 15 along an upper and a lower guides 13a. The resistor rollers 15 stop until the paper 14 comes, to which the top end of the paper 14 hits and a biased traveling of the paper 14 is corrected. Subsequently, the resist rollers 15 convey the paper 14 to the transferring portion in such a manner that it synchronizes with the top end of the image formed on the above described photosensitive drum 3. Note that, in the present embodiment, a paper feed sensor (not shown) is installed in the vicinity of the resist rollers 15 so that a paper feeding state, a paper jam and a length of the paper can be detected.

The paper 14 conveyed to the transferring portion in the above manner is given a charge of the polarity reverse to the toner from a transferring roller 7 which is transferring means from a back side of the paper 14, and the toner image formed on the above descried photosensitive drum 3 is transferred on the above described paper 14. The paper 14 transferred with this toner image is conveyed to the fixing apparatus 17 which is fixing means by a conveying roller 16a and a conveying guide 16b, and the above described fixing apparatus 17 dissolves and fixes the toner image on the paper 14 onto the paper 14 by heat and pressure, thereby making it as a recorded image. The paper 14 after the image was fixed is discharged to, for example, a discharging tray 18 through each conveying roller selected by a flapper (not shown).

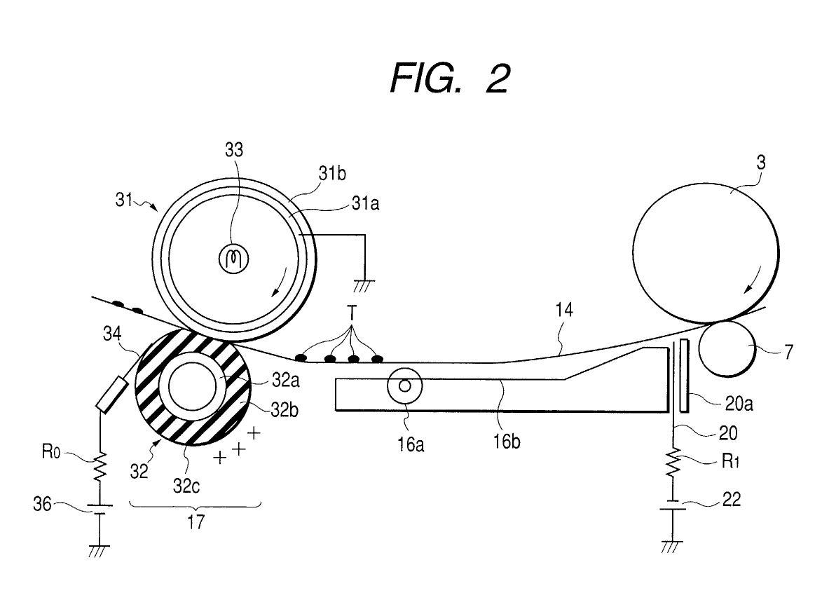

FIG. 2 is a view for explaining a transferring step to a fixing step.

In the present embodiment, in order to separate the paper 14 transferred with the toner image from the photosensitive drum 3, the printer is provided with a residual charge elimination needle 20 of the residual charge elimination means near the photosensitive drum 3, and the paper 14 after the transfer is applied with the bias reverse to the polarity of the bias applied with the transferring roller 7 so that the charge on the paper 14 is eliminated and the absorption force between the photosensitive drum 3 and the paper 14 is weaken.

The residual charge elimination means comprises a bias power source 22 which is a power source in addition to the residual charge elimination needle 20, a current-limiting resistor R₁ for preventing an electric current leakage by the power source 22, and a residual charge elimination needle holder 20a for shielding between the transferring roller 7 and the residual charge elimination needle 20 in order to prevent a leakage of the bias applied to the transferring roller 7 toward the residual charge elimination needle 20.

That is, the residual charge elimination means comprises the power source 22 which is the second power source and the resistor R₁ which is the second resistor connected in series to the second power source, and applies a voltage to the recording medium by the second power source through the second resistor.

In this way, the paper 14 which was separated from the photosensitive drum 3 is conveyed to the fixing apparatus 17 by the conveying roller 16a and the conveying guide 16b.

The fixing apparatus 17 comprises a fixing roller 31 which is a fixing member, a heater 33 which is heating means for heating the fixing roller 31 installed inside the fixing roller 31, and a pressure roller 32 which is pressed against the fixing roller 31 by 20 kgf by pressure means (not shown) and forms a fixing nip.

That is, the fixing means comprises a pair of fixing members, the fixing roller (heating roller) 31 is a first fixing member which contacts an unfixed toner image, the pressure roller 32 is a second fixing member which opposes to the first fixing member and does not contact the unfixed toner image, and the recording medium which bore the unfixed toner image by the fixing nip is held and conveyed, and the unfixed toner image is fixed on the recording medium.

The fixing roller 31 has an electrically conductive fluororesin layer 31b formed on a metal core 31a.

The pressure roller 32 has a heat resisting silicon rubber elastic layer 32b on a metal core 32a and, further, a low resisting fluororesin layer 32c is formed thereon. Note that the surface resistance of the low resisting fluororesin layer 32c of the pressure roller is equal to or less than 10⁶ Ω.

A thermister (not shown) abuts against the surface of the fixing roller 31 with a predetermined abutting pressure, and an electrical circuit (not shown) which is control means is allowed to turn on and off energization to a heater 33 based on the temperature detected by the above mentioned thermister in such a manner as to make the temperature of the surface of the fixing roller 31 constant during printing.

In this way, the unfixed toner image T is fixed on the paper 14 by being heated and pressurized in the fixing nip.

Voltage applying means comprises an electrically conductive member 34, a first power source 36, and a first resistor R₀ connected in series to the first power source 36, and applies a voltage to the second fixing member 32 by the first power source 36 through the first resistor R₀.

That is, in the present embodiment, by an electrically conductive brush 34 which is an electrically conductive member and binds together fibers such as stainless, amorphous and the like for supplying an electrical power, a bias reverse to the polarity of the unfixed toner image T is applied on the surface of the pressure roller 32 from the bias power source 36 which is the first power source through the current-limiting resistor R₀ which is the first resistor.

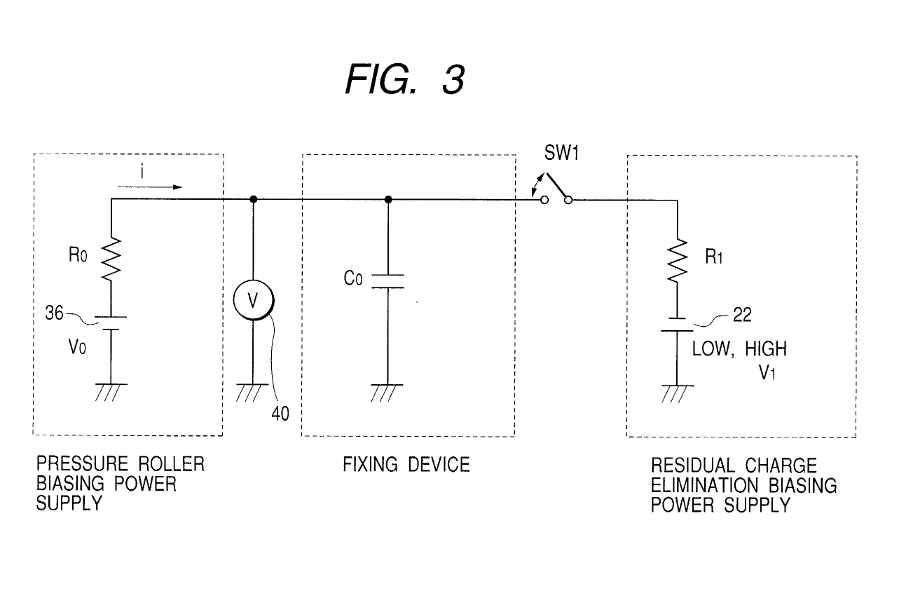

FIG. 3 typically shows the relation among the bias power source 22, the fixing apparatus 17 and the bias power source 36.

In the present embodiment, the recording medium having at least the maximum size exists by extending from the residual charge elimination means to the fixing means.

As shown in FIG. 3, the fixing apparatus 17 is provided with an electrostatic capacity C₀, and a bias reverse to the polarity of the toner is applied to the pressure roller 32 inside the fixing apparatus 17 by the DC bias power source 36 through the current-limiting resistor R₀. On the other hand, a bias V₁ applied to the residual charge elimination needle 20 is applied to the paper by matching a paper feeding timing of the paper from the DC bias power source 22 which connects in series the current-limiting resistor R₁. A SW1 is allowed to be in an off-state until the paper reaches the fixing apparatus and in an on-state when the humidified paper reaches the fixing nip. Because the resistance of the humidified paper is small, a space between the fixing apparatus 17 and the residual charge elimination needle 20 is in a short-circuit state. By a voltmeter 40, the voltage of the bias applied to the pressure roller 32 is allowed to be detected.

Conventionally, there have been some cases where before the paper reaches the fixing apparatus 17 (the SW1 is in a state of OFF), the bias applied by the bias power source 36 is accumulated in the pressure roller 32 and becomes a normal state, but when the humidified paper reaches the fixing apparatus 17 (the SW1 is in an ON state), the electric current i flows and the potential of the electrostatic capacity C₀, that is, the pressure roller 32 instantaneously falls in a voltage and the black spots of an unfixed image on the paper occurs.

Thus, in the present embodiment, the relation between the voltages V₀, V₁ by the power source and the current-limiting resistances R₀, R₁ was set as follows:

V₀·R₁>V₁·R₀ (1)

In this way, even when the residual charge elimination needle 20 applies a strong residual charge elimination bias to the paper at the paper rear end, the potential fluctuation of the pressure roller 32 is made small and the phenomenon of black spots at the fixing portion is attempted to be prevented.

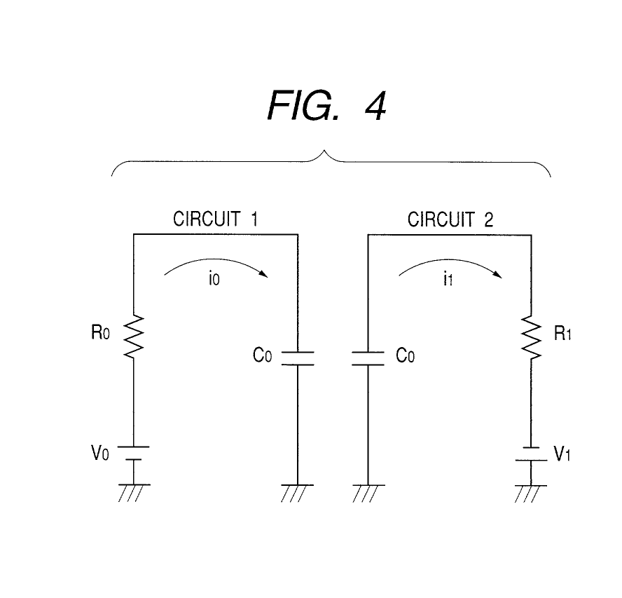

That is, when considering that the circuit of FIG. 3 is divided into two portions as shown in FIG. 4, in order not to allow the potential (V=Q/C₀) of the pressure roller to fluctuate, if an electric current i₀ which flows in the circuit 1 of FIG. 4 is made larger than the electric current i₁ which flows in the circuit 2, the electric current i₁ which flows in the paper by the residual charge elimination bias is caught by the electric current i₀ supplied from the pressure roller and consequently the charge stored in the electrostatic capacity C₀, that is, the potential of the pressure roller 32 does not fluctuate.

The electric currents which flow in the circuit 1, the circuit 2 are,

i₀=(V₀/R₀)exp(−(1/R₀C₀)t)

i₁=(V₁/R₁)exp(−(1/R₁C₀)t)

and, because a charge is not charged to the electrostatic capacity C₀ in the beginning, if t=0,

i₀=(V₀/R₀)

i₁=(V₁/R₁),

and therefore, to attain i₀>i₁,

V₀/R₀>V₁/R₁

V₀·R₁>V₁·R_{0,}

thus, satisfying the equation (1) is sufficient.

The actual application of the present embodiment to the laser beam printer of the reverse developing which uses a negative toner having a process speed of 200 mm/s will be described.

The present apparatus allows the transferring roller of φ18 to slavishly rotate on the photosensitive drum of φ30 and the residual charge elimination needle is arranged in the downstream vicinity of the transferring roller. By the residual charge elimination bias power source which connects the current-limiting resistor R₁=10 MΩ in series to this residual charge elimination needle, with the conveying timing of the paper synchronized, a residual charge elimination bias of a LOW level (=−1 kV) and a HIGH level=−3.0 kV (=V₁) at the paper rear end 20 mm were applied and it was possible to make an excellent conveyance and separation.

Further, as a fixing apparatus, a pressure roller of φ30 is abutted against a fixing roller of φ40 by a pressuring force of 30 kgf and slavishly rotated. On the surface of the pressure roller, the electrically conductive brush made of amorphous is abutted, and by the pressure bias power source which connects the current-limiting resistor R₀ in series, a pressure bias +1 kV (=V₀) was applied synchronized with the rotation of the fixing roller.

In this apparatus, when the current-limiting resistor R₀ was changed and a voltage drop ΔV of the pressure roller was measured, the result was shown as per TABLE 1. The potential of the pressure roller is the value of the voltmeter 40 of FIG. 3.

TABLE 1

| R₁ (MΩ) | R₀ (MΩ) | ΔV | Black spots |
|---|---|---|---|
| 10 | 100 | 1250 | BAD |
| 10 | 20 | 700 | NO GOOD |
| 10 | 10 | 450 | NO GOOD |
| 10 | 1 | 10 | GOOD |

In this case, when the current-limiting resistor R₀=1 (MΩ), which satisfies R₀<10/3≅3.3 (MΩ)from the equation (1), no black spot of the fixing portion was observed.

Therefore, as described above, according to the present embodiment, if the current-limiting resistors R₀, R₁ are set for the bias V₁ applied to the residual charge elimination needle which is set in advance and the bias V₀ applied to the pressure roller in such a manner as to satisfy the relation of the equation (1), the potential fluctuation of the pressure roller under high humidifying circumstance can be made small and black spots at the fixing portion can be prevented.

(Second embodiment)

Next, the second embodiment of the present invention will be described. Note that the components which are the same as those of the first embodiment are attached with the same reference numerals and the description thereof will be omitted.

In the present embodiment, a capacitor C₁ was connected in series to the bias power source applied to the pressure roller and the potential fluctuation of the pressure roller was made small so that the voltage between R₀ and C₁ was applied to the pressure roller.

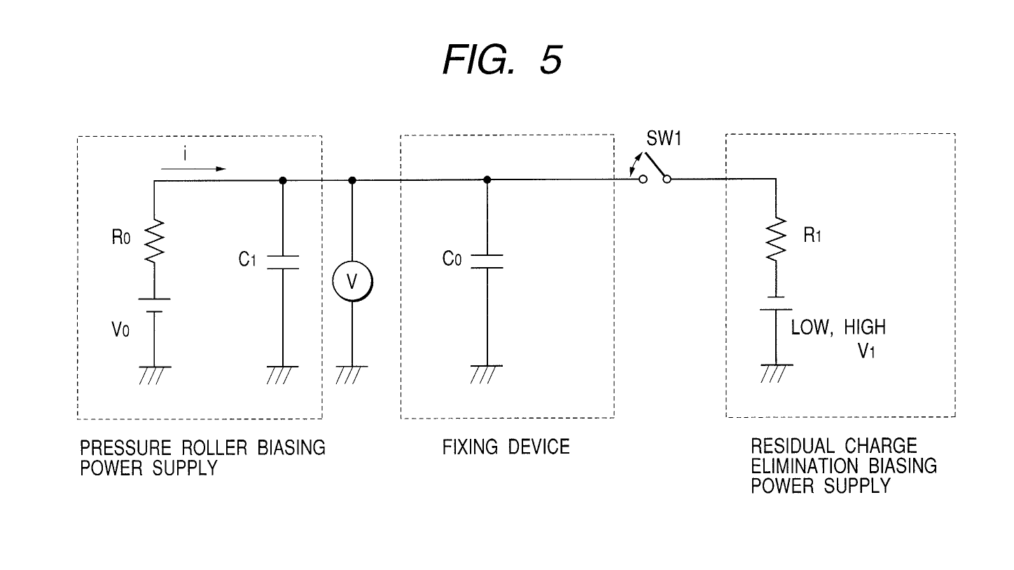

That is, because the capacitor C₁ is connected in parallel to the electrostatic capacity C₀ with which the fixing apparatus is provided in FIG. 5, the fact that the current-limiting resistor R₀ and the capacitor C₁ serve as the so-called integrating circuit was utilized.

Although the capacity of the capacitor C₁ can be randomly set, if the capacitor C₁ is too small, comparing with the electrostatic capacity C₀ of the fixing apparatus, the effect of making the potential fluctuation of the pressure roller small is minimized and if it is too large, the rise time of the bias applied to the pressure roller slows down and therefore the capacitor capacity of the same level as the electrostatic capacity C₀ of the fixing apparatus is preferable.

The actual application of the present embodiment to the same image forming apparatus as the first embodiment will be described.

The electrostatic capacity C₀ of the fixing apparatus of the first embodiment was 900 pF owing to the fall time of the pressure bias.

Hence, 1000 pF was connected to a high voltage power source portion of the main body of the image forming apparatus as the capacitor C₁, and the potential fluctuation ΔV of the pressure roller and black spots at the fixing portion were compared. The result is shown in the TABLE 2.

TABLE 2

| R₁ (MΩ) | R₀ (MΩ) | C₁ (pF) | ΔV | Black spots |
|---|---|---|---|---|
| 10 | 10 | 0 | 450 | NO GOOD |
| 10 | 10 | 1000 | 200 | FAIR |

As shown in TABLE 2, by connecting the capacitor C₁, the voltage drop of the pressure roller is reduced and a flying image of the fixing portion was alleviated.

Further, in the present embodiment, because the current-limiting resistor R₀ which is connected to the bias power source to be applied to the pressure roller can be made large, the safety of the image forming apparatus can be enhanced much more than that of the first embodiment.

(Third embodiment)

Next, the third embodiment of the present invention will be described. Note that the components which are the same as those of the first embodiment are attached with the same reference numerals and the description thereof will be omitted.

In the apparatus which applies a bias reverse to the polarity of the toner to the pressure roller, because a charge is provided to the paper from the surface of the pressure roller, when the paper is separated from the surface of the fixing nip, the surface of the fixing roller is subject to separating charge and a potential unevenness occurs on the fixing roller. As a result, a flying phenomenon occurs on a fixing roller cycle. Particularly in a high velocity image forming apparatus, because it is necessary to apply a large bias to the pressure roller, the potential unevenness on the fixing roller becomes large.

In order to prevent the separating strippable charge on the fixing roller in the paper rear end, when the bias to the pressure roller is turned OFF at a timing in which the paper rear end reaches the fixing nip, the separating charge can be eliminated.

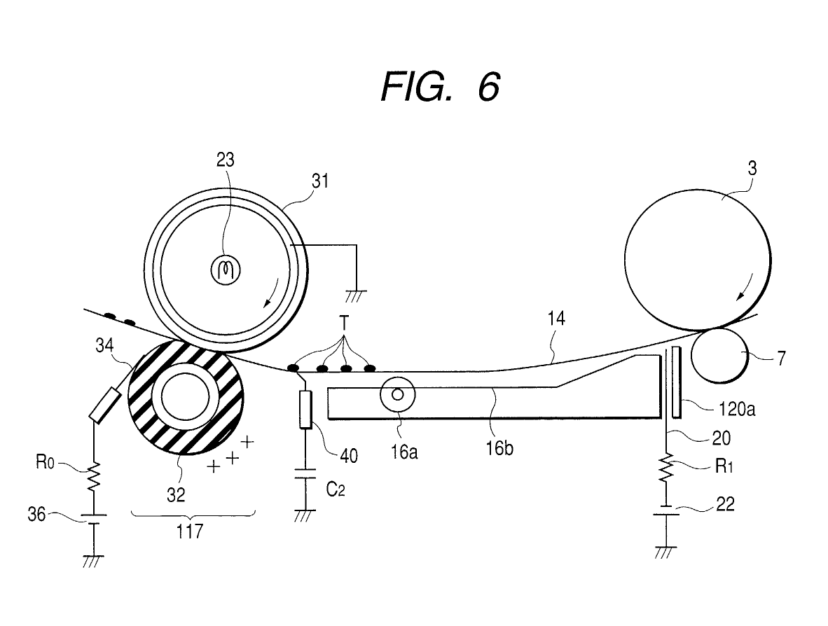

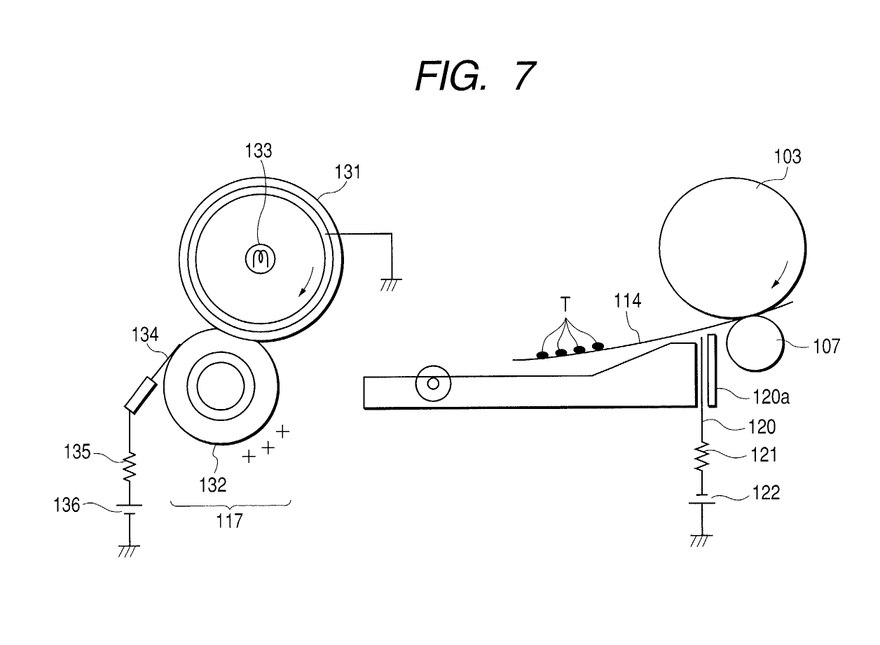

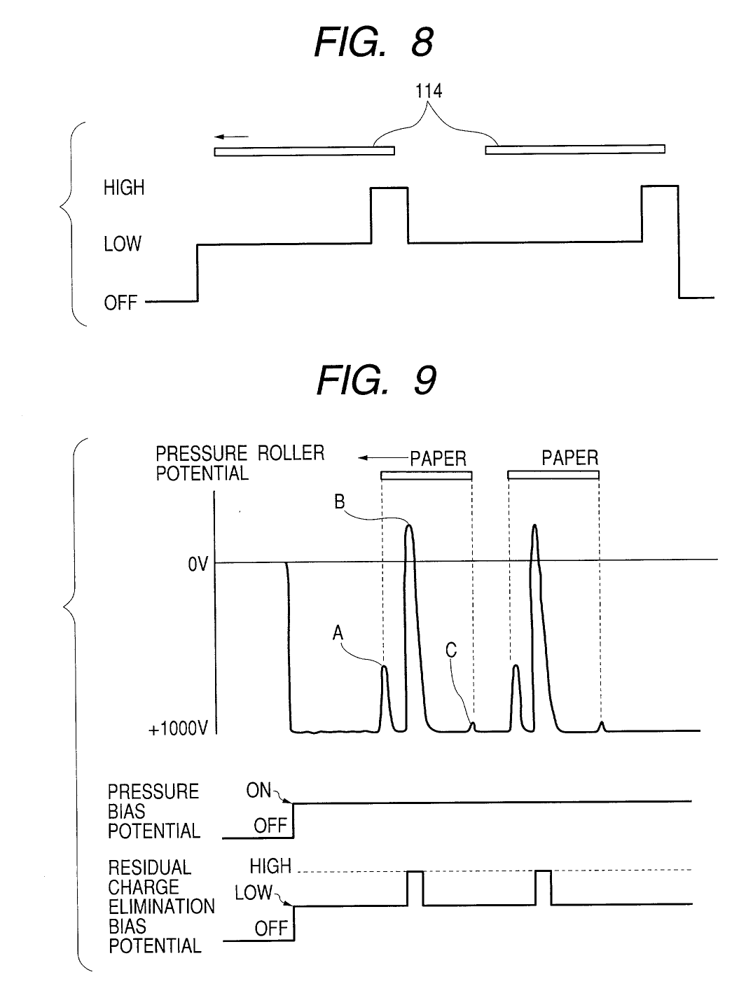

In the present embodiment, in the image forming apparatus for turning ON/OFF the applying of a bias to the pressure roller as shown in FIG. 6 by matching the conveying timing of the paper, an electrode member 40, which is an electrically conductive member and connects a capacitor C₂ in series between the residual charge elimination needle 20 after the transfer and the pressure roller 32, is arranged.

By arranging the capacitor C₂ between the residual charge elimination needle 20 and the pressure roller 32, the rise time and the fall time of the pressure bias are kept short because of no capacitor provided for the pressure bias power source portion so that the operation of the integrating circuit can be displayed similar to the second embodiment.

The above described ON/OFF application of the pressure roller bias to the image forming apparatus similar to the first embodiment will be practically described.

When, as a comparative example in the present apparatus, the timing of turning OFF the bias +1 kV to the pressure roller is set from 20 mm in front before the paper rear end reaches the center of the fixing nip, black spots on the humidified paper does not occur or the surface of the fixing roller is not charged by the paper rear end.

Hence, in the present embodiment, similar to the first embodiment, because the current-limiting resistor R₀ of the bias power source which is applied to the pressure roller is taken as 1 MΩ, the fall time of the pressure bias can be made fast as a time constant R₀·C₀=0.9 ms (=0.18 mm) and, before the next paper arrives, the pressure bias can be turned ON.

Furthermore, as the electrode member 40 which connects the capacitor C₂ (1000 pF) in series, the electrically conductive brush made of amorphous and SUS was arranged so as to come in contact with the paper to be conveyed and, therefore, even when a bias of −3 kV was applied to the paper rear end by the residual charge elimination needle, the flying in the humidified paper did not occur.

Consequently, as described above, according to the present embodiment, this was particularly effective for the image forming apparatus which turns ON/OFF the application of the bias to the pressure roller by matching the conveying timing of the paper.

Note that, in the first embodiment to the third embodiment, though the description was made by using the fixing roller as the fixing member, a film may be used as the fixing member.

As described above, according to the present invention, even under high humidity, the potential fluctuation of the pressing body at the time when the recording medium applied with a bias by the residual charge elimination means passes the nip can be controlled and black spots of the toner by the toner image on the recording medium at the time when the recording member passes the nip can be prevented.

While, as above, the embodiments of the present invention were described, the present invention is not intended to be limited to the above described embodiments, but is susceptible to various modifications within the spirit and the scope of the invention.

What is claimed is:

1. An image forming apparatus, comprising:
an image bearing body;
a transferring means for transferring a toner image on said image bearing body on a recording medium;
a fixing means for fixing an unfixed toner image transferred on a recording medium by said transferring means on the recording medium, the fixing means including a first and a second fixing members for conveying the recording medium with nipping;
a voltage applying means for applying a voltage to the second fixing member which does not come in contact with the unfixed toner image of said fixing means; and
a residual charge elimination means for eliminating a charge of the recording medium before being fixed by said fixing means;
wherein the recording medium of the maximum size at least extends from said residual charge elimination means to said fixing means,
wherein said voltage applying means comprises a first power source and a first resistor connected in series to said first power source and applies a voltage to said second fixing member from said first power source through said first resistor,
wherein said residual charge elimination means comprises a second power source and a second resistor connected in series to the second power source and applies a voltage to the recording medium from said second power source through said second resistor, and
wherein a voltage value (V₀) of said first power source, a resistor value (R₀) of said first resistor, a voltage value (V₁) of said second power source and a resistor value (R₁) of said second resistor, have a relation of V₀·R₁>V₁·R₀.

2. An image forming apparatus according to claim 1, wherein said voltage applying means applies a voltage of a polarity opposite to a polarity of a toner to a surface of said second fixing member.

3. An image forming apparatus according to claim 1, wherein a surface resistance of said second fixing member is equal to or less than 10⁶ Ω.

4. An image forming apparatus according to claim 1, wherein said first fixing member is a heating roller and said second fixing member is a pressure roller.

5. An image forming apparatus according to claim 1, wherein said residual charge elimination means applies a voltage of the same polarity as a polarity of a toner to the recording medium.

6. The image forming apparatus according to claim 1, wherein said residual charge elimination means charge-eliminates the recording medium after transferring by said transferring means.

7. An image forming apparatus, comprising:
an image bearing body;
a transferring means for transferring a toner image on said image bearing body on a recording medium;
a fixing means for fixing an unfixed toner image transferred on the recording medium by said transferring means on the recording medium, the fixing means including a first and a second fixing members for conveying the recording medium with nipping;
a voltage applying means for applying a voltage to the second fixing member which does not come in contact with the unfixed toner image of said fixing means; and
a residual charge elimination means for eliminating a charge of the recording medium before being fixed by said fixing means;
wherein the recording medium of the maximum size at least extends from said residual charge elimination means to said fixing means, and
wherein said voltage applying means comprises a power source, and a resistor and capacitor which are connected in series to said power source and applies a voltage between said resister and said capacitor to said second fixing member.

8. An image forming apparatus according to claim 7, wherein said residual charge elimination means comprises a power source and a resistor which is connected in series to said power source and applies a voltage to the recording medium by said power source through said resistor.

9. An image forming apparatus according to claim 7, wherein said voltage applying means applies a voltage opposite to a polarity of a toner to said second fixing member.

10. An image forming apparatus according to claim 7, wherein a surface resistance of said second fixing member is equal to or less than 10⁶ Ω.

11. An image forming apparatus according to claim 7, wherein said first fixing means is a heating roller and said second fixing means is a pressure roller.

12. An image forming apparatus according to claim 7, wherein said residual charge elimination means applies a voltage of the same polarity as a polarity of a toner to the recording medium.

13. An image forming apparatus according to claim 7, wherein said residual charge elimination means eliminates a charge of the recording medium after transferring by said transferring means.

14. An image forming apparatus, comprising:
an image bearing body;
a transferring means for transferring a toner image on said image bearing body on a recording medium;
a fixing means for fixing an unfixed toner image transferred on the recording medium by said transferring means on the recording medium, the fixing means including a first and a second fixing members for contacting with each other by pressuring conveying the recording medium with nipping by the pressured contact portion;
a voltage applying means for applying a voltage to the second fixing member which does not come in contact with the unfixed toner image of said fixing means; and
a residual charge elimination means for eliminating a charge of the recording medium before being fixed by said fixing means;
wherein the recording medium of the maximum size at least extends from said residual charge elimination means to said fixing means,
wherein said voltage applying means stopping applying a voltage to said second fixing means when the rear end of the recording medium arrives at the pressure-welded portions of said fixing means,
wherein an electrically conductive member coming into contact with the recording medium between said residual charge elimination means and said fixing means, and
wherein said electrically conductive member being grounded through the capacitor.

15. An image forming apparatus according to claim 14, wherein said voltage applying means comprises a power source and a resistor connected in series to said power source and applies a voltage to said second fixing member from said power source through said resistor.

16. An image forming apparatus according to claim 14, wherein said residual charge elimination means comprises a power source and a resistor connected in series to said power source and applies a voltage to the recording medium by said power source through said resistor.

17. An image forming apparatus according to claim 14, wherein said voltage applying means applies a voltage opposite to a polarity of a toner on a surface of said second fixing member.

18. An image forming apparatus according to claim 14, wherein a surface resistance of said second fixing means is equal to or less than 10⁶ Ω.

19. An image forming apparatus according to claim 14, wherein said first fixing member is a heating roller and said second fixing member is a pressure roller.

20. An image forming apparatus according to claim 14, wherein said residual charge elimination means applies a voltage of the same polarity as a polarity of a toner to the recording medium.

21. An image forming apparatus according to claim 14, wherein said residual charge elimination means eliminates a charge of the recording medium after transferring by said transferring means.
